(19) United States
(12) Patent Application Publication
(10) Pub. No.: US 2011/0041402 A1
(43) Pub. Date: Feb. 24, 2011

(54) PLANT PROPAGATION TRANSFER METHOD

(75) Inventor: Robert Dixon Teasdale, Chapel Hill (AU)

Correspondence Address: LARCHER & CHAO LAW GROUP, P.O. BOX 1666, SKOKIE, IL, 60076, US

(73) Assignee: NUPLANT PTY LTD, Toowong (AU)

(21) Appl. No.: 12/672,683

(22) PCT Filed: Aug. 11, 2008
(86) PCT No.: PCT/AU2008/001157

§ 371 Date: Feb. 8, 2010

(30) Foreign Application Priority Data
Aug. 10, 2007 (AU) 2007904319

(51) Int. Cl. A01G 9/10; A01G 9/02; A01G 31/00

(52) U.S. Cl. 47/59 S; 47/66.7; 47/65.7

(57) ABSTRACT

A plant propagation transfer method comprising the steps of segregating plantlets (14) from a tissue-culture medium into a root permeable container (10) containing an aqueous gel medium (13) including inorganic nutrient and supported in a support tube (12). The segregated plantlets (14) are acclimated in light and air until the roots extend toward the bottom of the container (10), before separating the container (10) from the support tube (12) and planting out while still in the container (10). The container (10) comprising a root permeable sleeve formed from a heat sealable, non-woven cellulosic tissue material having a proportion of polyolefin fibre therein is also disclosed.

### FIELD OF THE INVENTION

This invention relates to a plant propagation transfer method.

This invention has particular but not exclusive application to a plant propagation transfer method for hardening and planting out rooted plantlets, and for illustrative purposes reference will be further described with reference to this application. However, it is to be understood that this invention could be used in other applications, such as planting out generally.

### PRIOR ART

Unless explicitly indicated to the contrary, none of the following prior art constitutes common general knowledge in the art.

Plants grown under conditions for rapid vegetative multiplication, particularly using tissue culture, often result in small, weak plantlets poorly prepared for transfer to less supportive conditions, resulting in high levels of attrition, delays in growth, and greater management attention. “. . . transfer to less supportive conditions” as used herein includes, but is not limited to, transfer to a different growing medium such as being planted out in soil or soil analogues, whether in a tube, pot or otherwise. Multiple labour-requiring steps are often required to stage the transfer, often stressful to the plant.

For example, where plants are grown under tissue culture conditions on agarified media, these generally include sugars and other organic nutrients. The plantlets at this stage are largely non-photosynthetic and not ready for autonomous growth. Normally, the first step in transfer of plants grown under tissue culture conditions is to remove the organic nutrient-containing agar from the roots to prevent the nutrients supporting growth of fungi. This agar-removing step tends to damage the roots.

Plantlets freed of agar are then placed in soil and, depending on the species, tended under low light with misting. The misting is progressively reduced and light intensity increased to allow plants to adjust their physiology to new conditions. Attrition of 30% is not uncommon with standard procedures for transfer ex-vitro.

### DESCRIPTION OF INVENTION

As used herein the word “comprising” and its parts is to be taken as non-exclusive, unless context indicates clearly to the contrary.

This invention in one aspect resides broadly in a plant propagation transfer method including the steps of:
segregating plantlets from a tissue-culture propagation medium into a root-permeable container with an aqueous gel medium including inorganic nutrient;
acclimating said segregated plantlet in light and air until the roots extend toward the bottom of the container; and
planting out said acclimated plantlet in its container.

The root permeable container may be made from a material that is inherently root permeable such as perforated material, or may be of a substantially impermeable material rendered perforate before planting out. Alternatively, the material may progress from a root impermeable state to a permeable one by way of biological or environmental degradation. In a yet further alternative, the container may be formed of a woven material wherein the roots grow through and eventually displace the weave. Preferably the material is chosen to at least partially degrade in the environment before root growth can be impeded.

Examples of suitable environmentally degradable material include woven and non woven cellulose fibre materials, reconstituted cellulose materials such as films and rayon, modified cellulosic materials such as carboxymethyl cellulose, and cotton and other natural fibre in a woven or non woven fabric. In particular embodiments of the present invention the container is formed from a tubular stock of heat sealable, non-woven cellulosic tissue material having a proportion of polyolefin fibre incorporated therein to provide for heat sealability.

The root permeable container may take any selected physical form consistent with supporting the plantlet and its gel medium for acclimation and planting out. In particular embodiments of the present invention the container may take the form of a tube or the like. The tube may be self supporting. Alternatively the tube may be supported in a transport sleeve such as a polymer or waxed or laminated paper tube.

The root permeable container may be a cylindrical sleeve formed with a bottom closure portion to support the medium within the tube. Typically the tube may be about 15 to 25 mm in diameter and need not be more than about 25 mm long. However, the medium has some self supporting ability. Accordingly it is also an option to use a root permeable container which may be tapered toward an open bottom, the taper being sufficient for the medium to self-support within the root permeable container for handling. Typically a notionally 25 mm diameter container may tape to a lower opening of about 15 mm. The root permeable container may be a parallel-sided root permeable container with a short tapered portion toward the open bottom. Typically the effective taper described by measuring the top diameter and bottom diameter and drawing the line between the two is between 8 and 11 degrees.

The root permeable container may be any size selected to accept the plantlet without binding of the roots laterally and having sufficient length to allow for root growth during acclimation. In one embodiment of the invention, the container is comprised of a tube of tissue-paper that is synthetic fibre-reinforced for wet strength, and is approximately 50 mm tall and 16 mm in diameter to fit within a support tube of this size.

The aqueous gel medium including inorganic nutrient may be any phytocompatible supporting gel comprising an inorganic nutrient solution. For example, the solution may be gelled with an effective amount of a hydrocolloid gel forming material. The gel forming material may be selected from natural or synthetic hydrocolloid forming materials such as seaweed-derived gelling agents, agar, modified carbohydrate gelling agents or the like. Preferably the material forms a self supporting gel at low concentrations. For example, network gel polymers at ≦0.4% solids are preferred.

The inorganic nutrients may comprise any nutrient or combination of nutrients in concentration known in the art of hydroponic cultivation and propagation media. Organic nutrients are preferably avoided to reduce the likelihood of proliferation of contaminating micro-organisms such as fungi. In addition, the aqueous gel medium is preferably prepared under sterile conditions especially where the plantlets are segregated from sterile plant propagation stock. It has been surprisingly determined that acclimation in accordance with the present invention and in the substantial absence of organic nutrients in the tube medium such as sugars does not set the plantlets back. There is zero attrition attributable to the gel and a reduction in fungal infections both in acclimation and planting out.

The segregation of the plantlets into the aqueous gel medium including inorganic nutrient may be with or without removal of the source nutrient. In the case of plantlets raised in persistent agarified media, it may be appropriate to allow some pass-through of medium to prevent root damage by excessive cleaning. On the other hand, less persistent media may be removed by gently washing with an appropriate wash solution.

The acclimation conditions may be selected having regard to the plant variety involved. The conditions are at least as rigorous for the plant as the minimum conditions for conventional hardening up. In terms of light, it has been found that the acclimation process of the present invention can be done under a wide range of light conditions, including ambient nursery lighting conditions. In addition, misting is not necessary, with standard nursery conditions of temperature and humidity being adequate. No specialised atmosphere is required; species that are weaned off low O₂/high CO₂ atmospheres may be acclimated under ambient atmospheric conditions.

Acclimation may occur for any suitable period of time determined principally by the survival of planted out plantlets and will vary from variety to variety. As a general rule, acclimation will continue to advantage the plant until the plant roots approach the bottom of the container.

When the plantlet is established adequately, the container is used to support transfer to soil of the intact column of gelled solution including the growing plantlet. Roots on the plantlet are protected within the gel that is held intact by the container. Not only are roots protected by this system, but they are functional to the depth of the container for better establishment in the soil. In addition the column of gelled solution provides a water resource that buffers the plant in the event of variation in watering regime. The plantlets are cultivated as for normally hardened plantlets in terms of daily watering, etc.

In another aspect the invention resides broadly in a plant propagation container comprising a root permeable sleeve formed from a heat sealable, non-woven cellulosic tissue material having a proportion of polyolefin fibre incorporated therein.

The container may be adapted to be supported in a transport sleeve during segregation and/or acclimation. The root permeable container may be a cylindrical sleeve formed with a bottom closure portion to support the medium within the tube. Alternatively the root permeable container may be tapered toward an open bottom, the taper being sufficient for the medium to self-support within the root permeable container for handling. The effective taper may be provided where the root permeable container is a parallel-sided root permeable container with a short tapered portion toward an open bottom.

The root permability of the sleeve may be enhanced by providing a plurality of perforations there through.

### BRIEF DESCRIPTION OF THE DRAWINGS

In order that this invention may be more readily understood and put into practical effect, reference will now be made to an embodiment of the invention, elements of which are illustrated in the drawings wherein:

FIG. 1 is an exploded view of apparatus for use in the method of the present invention;

FIG. 2 shows the apparatus of FIG. 1 and including a plant acclimating;

FIG. 3 shows the acclimated plant, container and gel ready for planting out; and

FIGS. 4 to 6 show an alternative embodiment of a root permeable container for use in the method of the present invention.

### DESCRIPTION OF THE EMBODIMENTS

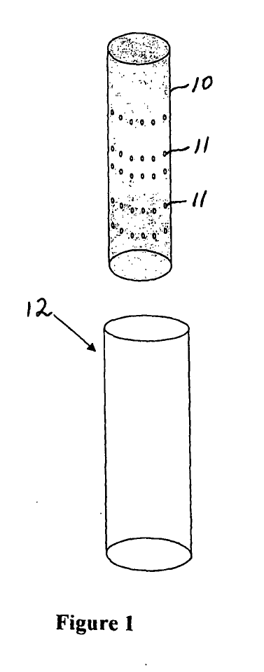

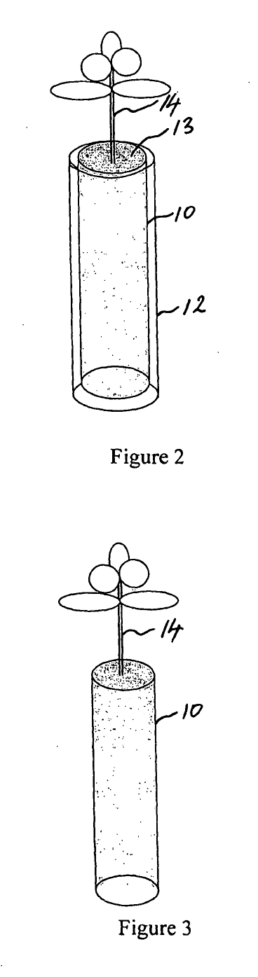

In the FIGS. 1 to 3, there is provided a container or “plantlet sock” (10) comprising a tube of tissue-paper that is polyolefin fibre reinforced for wet strength and heat sealability. The tube is formed by heat sealing and the side walls are provided with perforations (11). While the tissue material is inherently root-permeable, the supplementary perforations assist the growing-out of the plant. The container is about 50 mm tall and 16 mm in diameter and fitted within a support tube (12) of this size.

Under conditions of sterility of all materials, liquid nutrient solution (13) including the inorganic components of propagation medium for potato and containing agar gelling agent (J3 from Gelita Australia Pty Ltd, 0.4% agar equiv.) is poured into the tube-supported plantlet sock. A propagated potato plantlet (14) for which roots have been initiated is planted into the gel, tube and plantlet sock assembly (after cooling to a physiologically tolerable temperature) with minimal stripping of the propagation medium.

Tubes (12) are racked and the plantlet (14) acclimated under ambient light and standard atmosphere until the lead roots were nearly 50 mm long. The plantlet sock, gel and plant are withdrawn as a unit from the tube (12), then simply and directly transferred into soil that had been dibbled to accept the entire plantlet sock. The plants are maintained by simple daily watering, and roots penetrated the plantlet sock and continued their growth directly into the soil. The potato plantlets maintained the fast growth of the preceding tissue culture regime. No attrition was incurred.

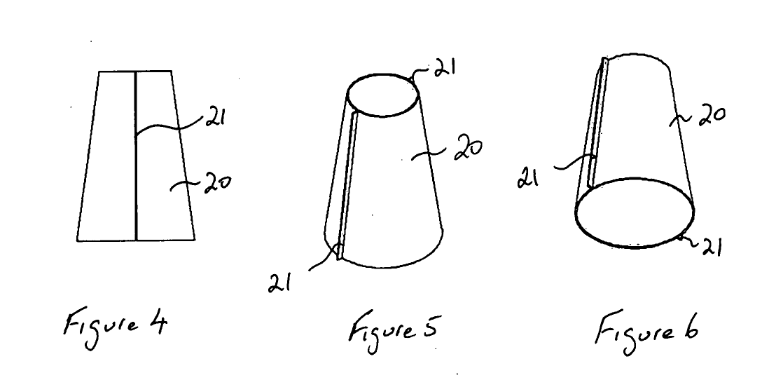

In the embodiment of FIGS. 4 to 6, there is provided a container comprising a frusto-conical of tissue-paper that is polyolefin fibre reinforced for wet strength and heat sealability. The body (20) is formed from two halves by heat sealing at (21) to form a side wall that is provided with perforations as for the previous embodiment (not shown). The container is about 50 mm tall, 17.6 mm across the upper diameter and 13 mm across the lower diameter. The container fits within a similarly shaped support tube (not shown).

The method of the present invention has also been trialed successfully on grapevines and may find application in respect of any other commercial plants amenable to propagation in culture, including but not limited to varieties of eucalypts, and teak and mahogany. The method is suitable for transfer to nursery conditions and, in cases where environmental conditions are appropriate, can allow direct field planting with mechanical handling. A procedure is described that substantially simplifies plantlet transfer for more effective establishment to soil, allowing direct transfer to field conditions.

It will of course be realised that while the above has been given by way of illustrative example of this invention, all such and other modifications and variations thereto as would be apparent to persons skilled in the art are deemed to fall within the broad scope and ambit of this invention as defined in the following claims.

1. A plant propagation transfer method including the steps of:
segregating plantlets from a tissue-culture propagation medium into a root-permeable container with an aqueous gel medium including inorganic nutrient;
acclimating said segregated plantlet in light and air until the roots extend toward the bottom of the container; and
planting out said acclimated plantlet in its container.

2. A plant propagation transfer method according to claim 1, wherein the root permeable container is formed from a tubular stock of heat sealable, non-woven cellulosic tissue material having a proportion of polyolefin fibre incorporated therein.

3. A plant propagation transfer method according to claim 1, wherein the container is supported in a transport sleeve during segregation and/or acclimation.

4. A plant propagation transfer method according to claim 1, wherein the root permeable container is a cylindrical sleeve formed with a bottom closure portion to support the medium within the tube.

5. A plant propagation transfer method according to claim 1, wherein the root permeable container is tapered toward an open bottom, the taper being sufficient for the medium to self-support within the root permeable container for handling.

6. A plant propagation transfer method according to claim 5, wherein the root permeable container is a parallel-sided root permeable container with a short tapered portion toward the open bottom.

7. A plant propagation transfer method according to claim 1, wherein the aqueous gel medium including inorganic nutrient includes a phytocompatible supporting gel comprising an inorganic nutrient solution gelled with an effective amount of a hydrocolloid gel forming material.

8. A plant propagation transfer method according to claim 1, wherein the aqueous gel medium is prepared under sterile conditions and the plantlets are segregated from substantially sterile plant propagation stock.

9. A plant propagation transfer method according to claim 1, wherein the acclimation conditions are standard nursery conditions of light, temperature and humidity.

10. A plant propagation transfer method according to claim 1, wherein acclimation is allowed to proceed until the plant roots approach the bottom of the container.

11. A plant propagation container comprising a root permeable sleeve formed from a heat sealable, non-woven cellulosic tissue material having a proportion of polyolefin fibre incorporated therein.

12. A plant propagation container according to claim 11, wherein the container is adapted to be supported in a transport sleeve during segregation and/or acclimation.

13. A plant propagation container according to claim 11, wherein the root permeable container is a cylindrical sleeve formed with a bottom closure portion to support the medium within the tube.

14. A plant propagation container according to claim 11, wherein the root permeable container is tapered toward an open bottom, the taper, being sufficient for the medium to self-support within the root permeable container for handling.

15. A plant propagation container according to claim 14, wherein the root permeable container is a parallel-sided root permeable container with a short tapered portion toward the open bottom.

16. A plant propagation container according to any one of claims 11 to 15, wherein the root permability of the sleeve is enhanced by providing a plurality of perforations there through.
